(19) United States
(12) Patent Application Publication
(10) Pub. No.: US 2014/0344301 A1
(43) Pub. Date: Nov. 20, 2014

(54) SYSTEM AND METHOD FOR MANAGING DRILLING

(71) Applicant: Chesapeake Operating, Inc., Oklahoma City, OK (US)

(72) Inventor: Casey McDonough, Edmond, OK (US)

(73) Assignee: Chesapeake Operating, Inc., Oklahoma City, OK (US)

(21) Appl. No.: 13/957,159

(22) Filed: Aug. 1, 2013

Related U.S. Application Data
(60) Provisional application No. 61/823,287, filed on May 14, 2013.

(51) Int. Cl. G06F 17/30

(52) U.S. Cl. CPC G06F 17/30554
USPC 707/758

(57) ABSTRACT

A system and method for drilling management is disclosed. More particularly, the present invention relates to the management of drilling data such that, among other things, drilling can be controlled to prevent the encroachment into other boreholes and into non-leased tracts of oil and gas assets. The present invention provides for a computer-based system that generates and sends electronic notices within certain well-related events which occur, such as the downloading of drilling information or when the wellbore being drilled approaches another wellbore or a non-leased tract.

### CROSS-REFERENCE TO RELATED APPLICATIONS

This application claims the benefit of U.S. Provisional Application No. 61/823,287 filed May 14, 2013, which is hereby incorporated by reference.

### FIELD OF THE INVENTION

The present invention relates to the management of drilling. More particularly, the present invention relates to the management of drilling data such that, among other things, drilling can be controlled to prevent the encroachment into other wellbores and into non-leased tracts of oil and gas assets.

### BACKGROUND OF THE INVENTION

As the world's reserves of fossil fuels diminish, wells are becoming increasingly difficult and correspondingly expensive to drill, and operational mistakes have potentially serious, not to mention extremely expensive, effects. Any loss of drilling time caused by unwanted events is undesirable.

As part of the drilling and operation of wells, a large amount of related data is generated. The data includes large sets of sophisticated sensor measurements and data related to various other drilling parameters. This data includes continuous (real time) data streams from the drilling operation, such as that obtained by Measurement While Drilling (MWD) processes. However, current software tools do not adequately disseminate this information to personnel needing it nor do they adequately process the information to help avoid operational mistakes. As the amount of available data increases, the need for software tools to extract, or filter out relevant information in a given situation increases correspondingly. Additionally, the need to place relevant information in the hands of the correct personnel increases.

### SUMMARY OF THE INVENTION

According to one aspect of the present invention, there is provided a computer-based system for managing data associated with drilling. The system comprises at least one database for storing data associated with drilling including current data related to a wellbore currently being drilled and zone data related to a zone not to be drilled. The system further comprises at least one server configured to generate a graphical user interface at a plurality of locations over a network. The graphical user interface enables viewing and entry of well-related data. The server generates a plurality of electronic notifications wherein each notification is associated with at least one predefined well event occurring. The server also generates a comparison of the current data and the zone data, and one of the electronic notifications is a zone notification which is generated when the comparison indicates that the wellbore currently being drilled is within a predefined range from a zone not to be drilled.

In accordance with another aspect of the invention, there is provided a computer-implemented method comprising:
providing zone data related to a zone not to be drilled;
providing current data related to a wellbore currently being drilled;
comparing the current data to the zone data; and
generating a zone notification when the comparing indicates the wellbore is within a predefined range from the zone.

In accordance with yet another aspect of the invention, there is provided an article of manufacture including a non-transitory tangible computer readable storage medium having instructions thereon that, in response to execution by a computer-based system for managing data associated with drilling, cause the computer-based system to be capable of performing operations comprising:
comparing current data related to a wellbore currently being drilled to zone data related to a zone not to be drilled; and
generating a zone notification when the comparing indicates a wellbore is within a predetermined range from the zone.

### BRIEF DESCRIPTION OF THE DRAWINGS

FIG. 1 illustrates the implementation of a drilling management system in accordance with one embodiment of the current invention.

FIG. 2 is a flow chart illustrating the data input and notification features of the drilling management system.

FIG. 3 is a graphical representation of a wellbore and various no-drill zone areas.

FIG. 4 is another graphical representation of a wellbore and various no-drill zone areas.

FIG. 5 is yet another graphical representation of a wellbore and various no-drill zone areas.

FIG. 6 is a chart illustrating various functionalities of the drilling management system in accordance with an embodiment of the current invention.

FIG. 7 illustrates a graphical user interface of the dashboard page of an exemplary drilling management system.

FIG. 8 illustrates a graphical user interface of the search page of an exemplary drilling management system.

FIG. 9 illustrates a graphical user interface of the rig favorite page dashboard page for the manage account link of an exemplary drilling management system.

FIG. 10 illustrates a graphical user interface of the notification page for the manage account link of an exemplary drilling management system.

FIG. 11 illustrates a graphical user interface of the well summary page of an exemplary drilling management system.

FIG. 12 illustrates a graphical user interface of the well plan page of an exemplary drilling management system.

FIG. 13 illustrates a graphical user interface of the survey page of an exemplary drilling management system.

FIG. 14 illustrates a graphical user interface of the threshold page of an exemplary drilling management system.

### DESCRIPTION OF EXEMPLARY EMBODIMENTS

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

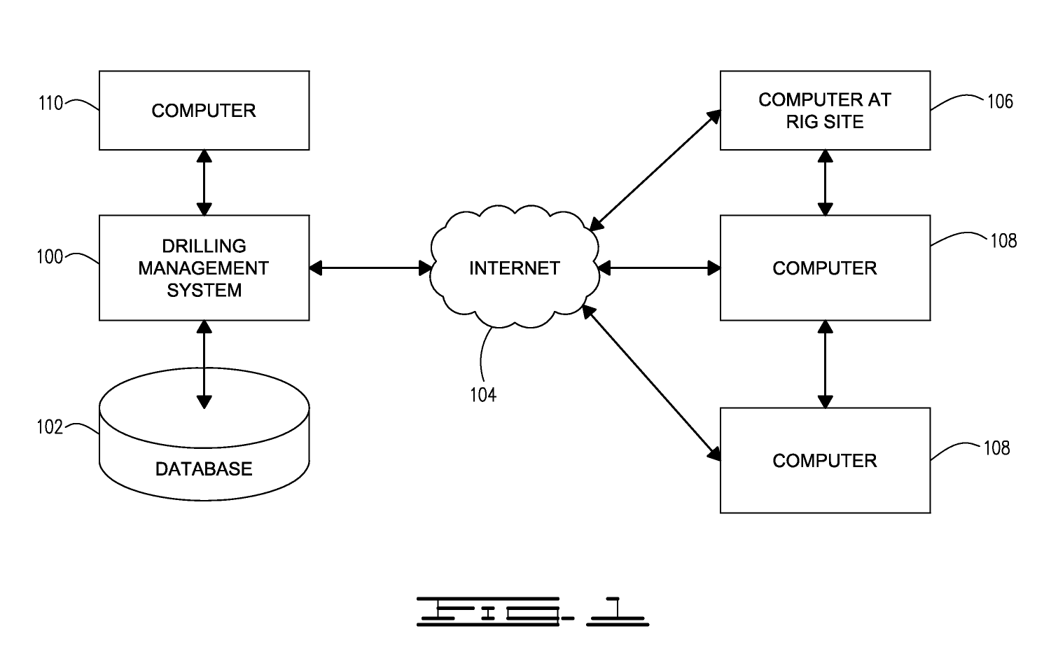

Referring now to FIG. 1, there is illustrated the general concept of the implementation of a drilling management system 100 over a network 104 such as the internet. While the following description envisions the use of the drilling management system 100 upon the internet or similar network, the system may also be implemented within a smaller local area network or wide area network or additionally could be implemented upon a single computer wherein the described system for managing drilling could be used by a single company or user.

The drilling management system 100 acts as a central repository for managing information related to the drilling of a wellbore and typically to a wellbore for extracting oil and/or gas from a reservoir. Drilling information is provided to the drilling management system 100 and can be stored in a centralized database 102; accordingly, typically database 102 will be part of the drilling management system but is referred to herein as a separate component for convenience. As will be appreciated by one of ordinary skill in the art, individual components of the drilling management system 100 may take the form of an entirely software embodiment, an entirely hardware embodiment, or an embodiment combining aspects of both software and hardware. Furthermore, individual components of the drilling management system 100 may take the form of a computer program product on a computer-readable storage medium having computer-readable program code embodied in the storage medium. Generally, the computer-readable storage medium will be non-transitory. Any suitable computer-readable storage medium may be utilized, including hard disks, CD-ROM, optical storage devices, magnetic storage devices, and/or the like.

The drilling information can be real time drilling data provided through drilling sensors and surveys taken in the wellbore during drilling or at the rig site. Such real time data can be relayed from the sensors through a computer 106 at the rig site to the drilling management system 100. Additionally, data and information can be manually entered through the computer 106 at the rig site or through one or more computers 108 and 110, located off site from the rig site. Rig-site computers 106 and non-rig site computers 108 each can access the drilling management system 100 through an open network, such as the internet 104. Non-rig site computer 110 can access the drilling management system 100 through a local area network or LAN.

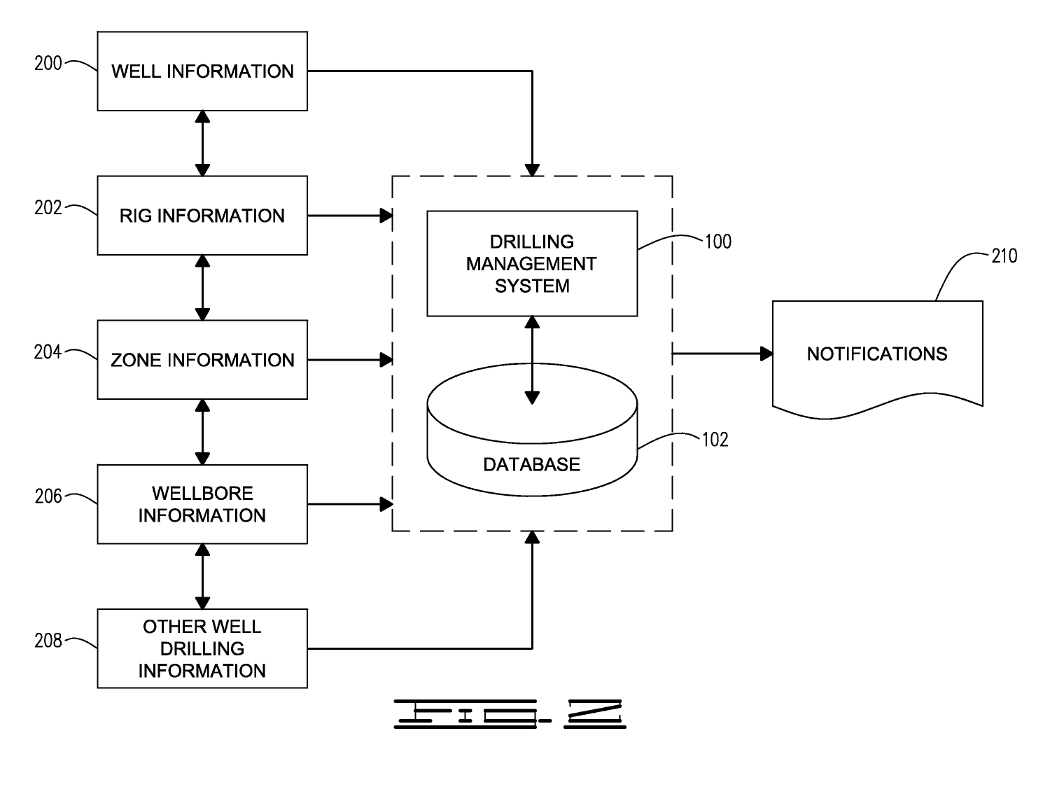

Once data related to the drilling has been stored within the database 102, the information can be accessed through computers 106, 108 and 110 by accessing a graphical computer interface, as more fully explained below. Additionally, the drilling management system 100 can issue notifications to one or more users based on the status and information available about one or more wells. Turning now to FIG. 2, this notification feature will be more fully explained.

FIG. 2 is a flow chart illustrating the general input of data into the well management system 100 and database 102, and the issuing of notifications 210 by the drilling management system 100. In FIG. 2, well information or well data 200 from other databases is extracted, transformed and loaded (ETL) into database 102 of well management system 100. Generally, this is carried out by known ETL processes and can include extracting information from such other databases for use in the drilling management system. Such information typically includes well name, spud date and location information, such as county, state, district, surface location, property number and similar. Rig information or rig data 202 is also loaded into database 102. Rig information can include such data as rig name, rig height and similar. The rig information will typically be manually entered but can be extracted from other databases by ETL processes. Zone data or zone information 204 on areas not to be drilled or not available for oil and gas production is introduced into to the database. Generally the zone information 204 can be location information on a tract or tracts of land not leased for oil and gas production but near or adjacent to the tract of land leased. As used in the foregoing sentence, “near” means that the non-leased tract is within range of the rig such that a wellbore located on the leased tract could feasibly reach the non-leased tract or such that a wellbore on the leased tract could drain from a reservoir in the non-leased tract during normal operation of the wellbore or during fracking operations or other advanced recovery techniques. The term “adjacent” means that the non-leased tract and leased tract share at least one common boundary. It should be understood that even though the leased tract is referred to in the singular, it encompasses multiple leased tracts where those leased tracts are near or adjacent and could be subject to oil and gas production from a common wellbore. Additionally, the zone information can include other areas that are not to be drilled or are not available for oil and gas production, such as the location of preexisting drilled wellbores; i.e. preexisting wellbores.

During drilling operations, wellbore information or wellbore data 206 is sent to the drilling management system 100 and stored in database 102. Generally, the wellbore information will be survey data taken during drilling, such as location and direction data of the wellbore including measured depth, inclination and azimuth of the wellbore. The measured depth is the length of the drilled wellbore, the inclination is the slope of the wellbore and the azimuth is the angle from the rig indicating the geographical cardinal direction of the wellbore. Such survey information can be taken by Measurement While Drilling (MWD) tools. MWD tools and processes are known in the art. In addition to direction and drilling information, the wellbore information can include other measurements taken by MWD processes, such as rotational speed of the drill string, smoothness of the rotation, type and severity of any vibration downhole, downhole temperature, torque and weight on bit and mud flow volume. In order to provide for timely notifications as explained below, the wellbore information should be introduced to the drilling management system 100 as soon as possible after it is obtained. Typically, the wellbore information will be real-time survey data, which is introduced to the drilling management system 100 as the rig site computer 106 obtains the survey data from sensors in the drill string.

Additionally, other well drilling information or data 208 can be added to the drilling management system 100 and stored in database 102 as desired. For example, drilling mud information (such as used drilling mud viscosity and drill cutting content) and reports on the drilling operation can be introduced to the drilling management system 100 and stored in database 102.

The drilling management system 100 is configured to send out various notifications 210. Typically, notifications 210 are electronic messages to users who have designated that they should receive the notifications. Generally, the electronic messages are sent from within drilling management system 100 to outside systems; thus, the electronic messages can be emails sent to a predefined email address for the user. Alternatively, electronic messages can be any suitable electronic message, such as text messages to a predefined phone number for the user.

One particularly advantageous notification is a location proximity notification. As drilling management 100 system receives the survey data from a wellbore being drilled, the system calculates the course and location of the wellbore. The system compares this to the zone data. If the wellbore comes within a predefined range of an area not to be drilled or not available for oil and gas production (“no-zone area”), the system generates a notification and sends it to the defined users informing the users that the wellbore is approaching and/or entering a no-zone area.

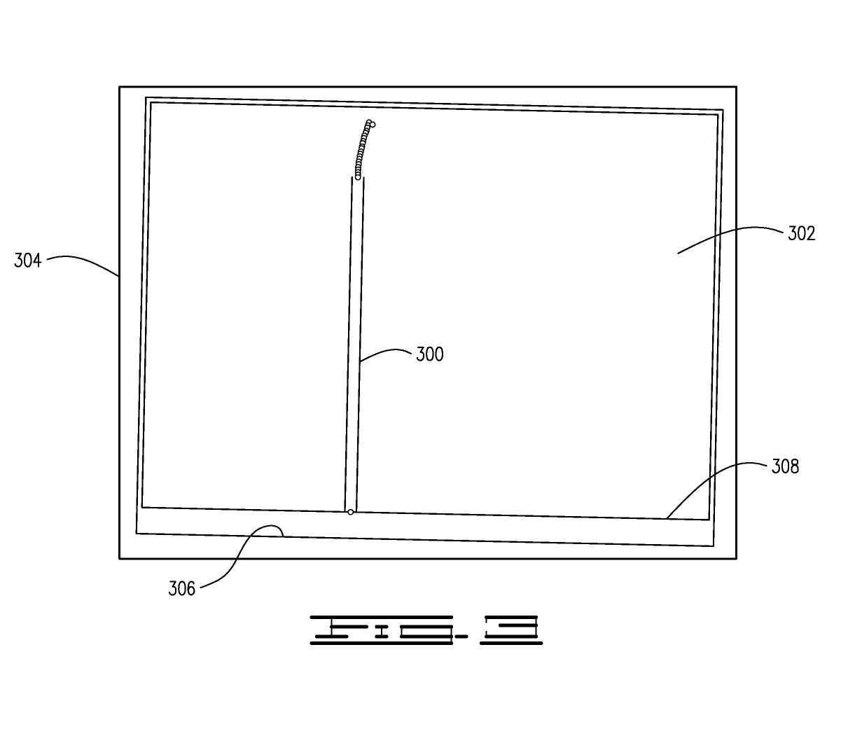

One example of such a no-zone area notification is illustrated in FIG. 3. Wellbores generally are not to be drilled within an established range of the border of a non-leased tract; thus, there might be an offset of 500 feet; that is, the wellbore should not be drilled to extend within 500 feet of the non-leased tract's border. In FIG. 3, wellbore 300 is being drilled in leased tract 302. Border 304 of a non-leased tract is a no-zone area and there is an offset 306. The drilling management system 100 is set to send out a first notification when the wellbore is drilled to within 60 feet of the offset represented by line 308. A second notification could be set for when the wellbore is drilled to within 50 feet of the offset. Additional notifications could also be provided.

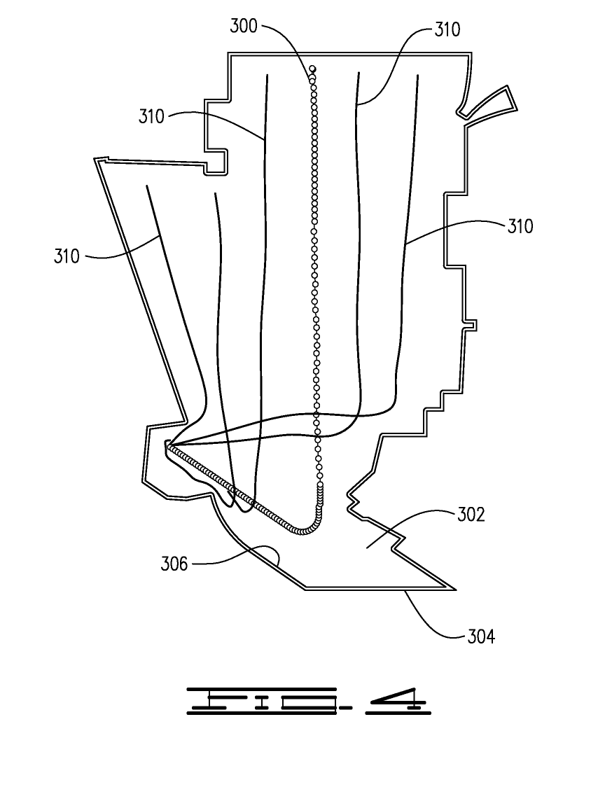

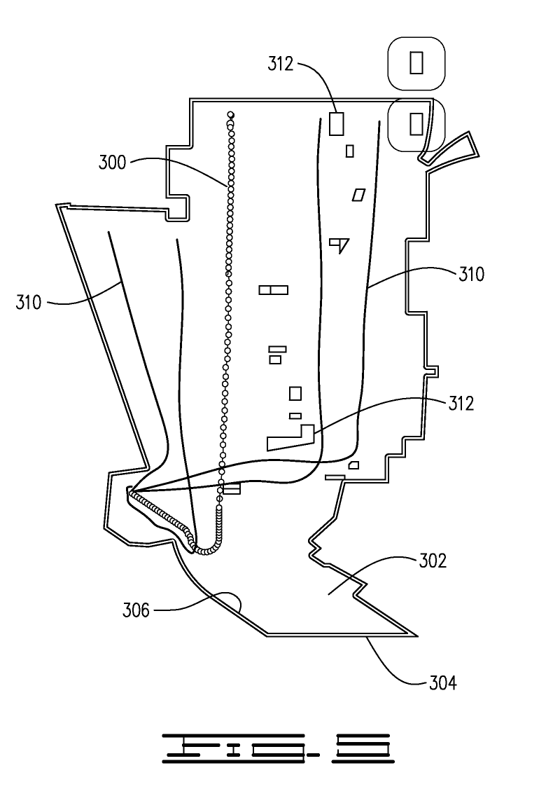

Other examples are illustrated in FIGS. 4 and 5. In FIG. 4 multiple preexisting wellbores 310 exist and have been drilled at sometime before wellbore 300. Preexisting wellbores 310 are no-zone areas because drilling into one or more of preexisting wellbores 310 can be costly and require drilling a replacement well for wellbore 300. Drilling management system 100 sends out collision notifications if wellbore 300 approaches one of preexisting wellbores 310. FIG. 5 has additional no-zone areas 312. No-zone areas 312 can be non-leased areas within leased tract 302 or can be areas where drilling and/or production are not allowed for other reasons. Drilling management system 100 sends out notifications if a no-zone area 312 is approached.

Additionally, drilling management system 100 can be set to give other notifications. These notifications are each associated with at least one predefined well event. The predefined well event could be related to data updates, such as updates to well logging data, mud logs, end of well reports and similar. Also, the predefined well event could be related to operational parameters, such as if the actual drilling path deviating more than a predefined amount from a predefined target well path.

Returning now to FIG. 1, access of drilling management system 100 by computers 106, 108 and 110 can be implemented in a number of fashions. In one embodiment, access is by using a commercially available browser such as Microsoft Explorer, Mozilla Firefox, Safari, etc. Additional implementations might utilize dedicated browser software that was specifically directed to communicating with drilling management system 100. In this case, a commercially available browser would not be necessary, but the software of the dedicated browser would have to be loaded onto the computers 106, 108 and 110 either by downloading the software or installing the software from a provided media. The installed software would be dedicated to communication with the drilling management system 100.

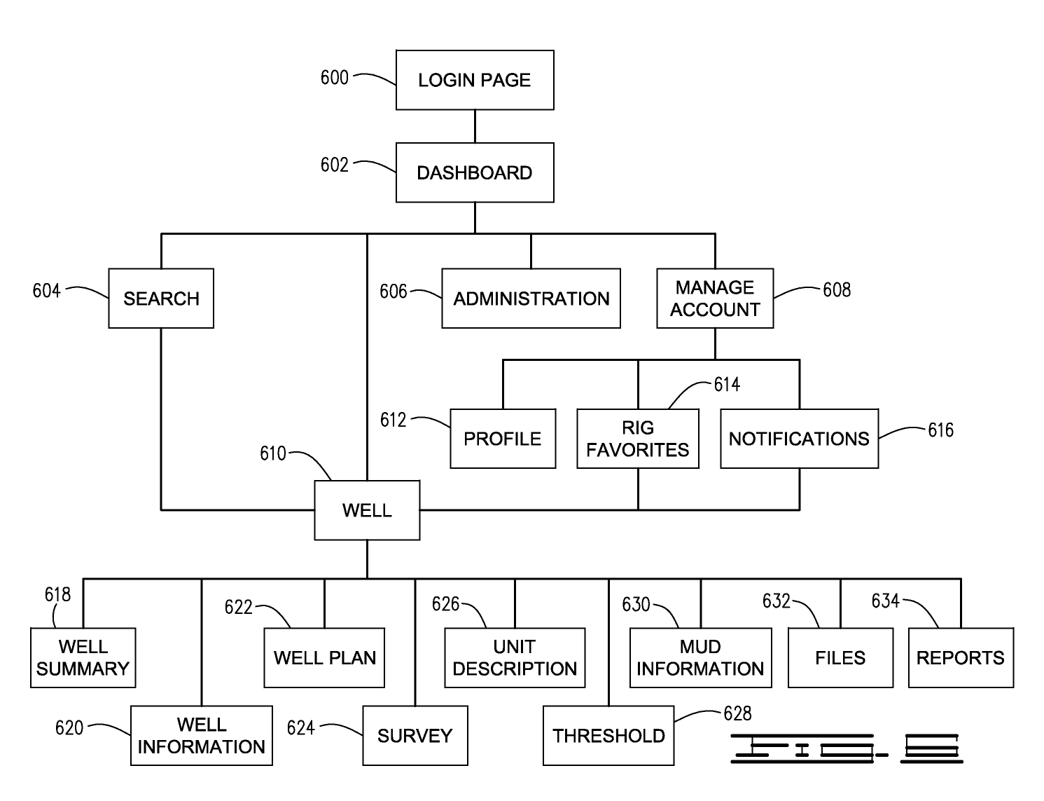

No matter what implementation for accessing the drilling management system 100 is utilized, drilling management system 100 provides a number of important functionalities to users of the system. Referring now to FIG. 6, there is provided a general functional illustration of the browser interface through which the user may enter and access drilling management system 100. The functionalities are collected onto different pages and tabs on the pages in the graphical user interface. Login page 600 enables users to login into drilling management system 100. Existing users are able to enter a user ID/password combination that provides them access to dashboard page 602. The dashboard page 602 provides access or links to all the various functionalities of the drilling management system 100 as will be described more fully herein below. From dashboard page 602, the user can navigate to search page 604, administrative page 606, manage account page 608 and well page 610.

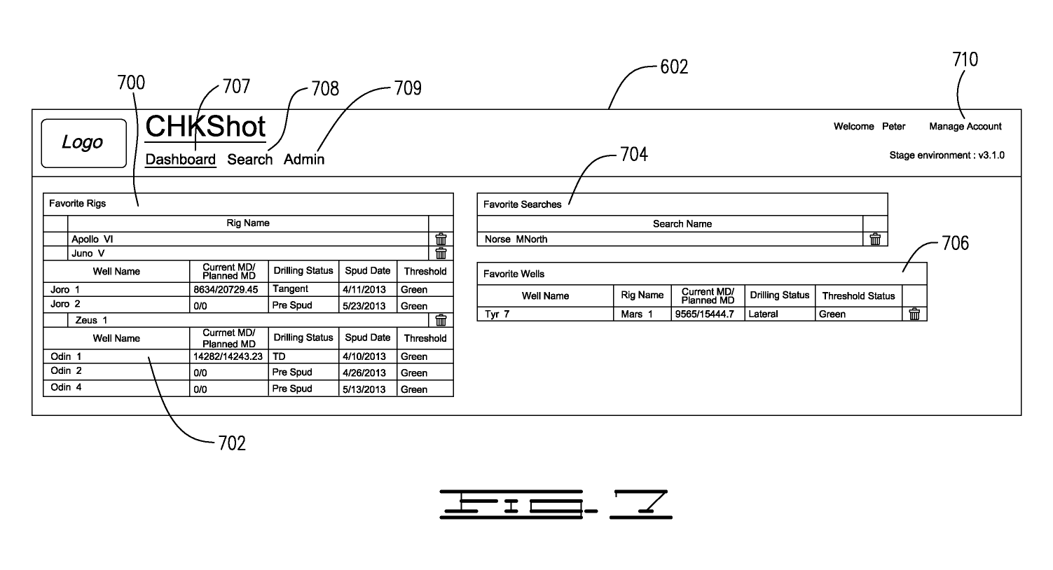

Referring now to FIG. 7, there is illustrated an exemplary dashboard page 602. Dashboard page 602 includes links 707, 708, 709 and 710 to dashboard 602, search page 604, administration page 606 and manage account page 608, respectively. Dashboard page 602 has several panels. Favorite rigs panel 700 lists rigs that have been selected as being of interest to the user for inclusion as favorite rigs. Favorite rigs panel 700 can be a collapsible panel; thus, each rig entry may be expanded to show a listing of well names 702 associated with the rig. Next to the well name can be information on the well such as spud date, current drilling status and threshold status. The well name is linked to the well page for that specific well and, thus, the user can move to the well page by selecting the well name, such as by clicking with a mouse or similar selection means. Additionally, dashboard page 602 includes a favorite searches panel 704. By clicking or otherwise selecting a listed search, the user can run a stored search. Also, there is a favorite well panel 706, which lists rigs that have been selected as being of interest to the user for inclusion as a favorite well. These well listings are also linked to the appropriate well page.

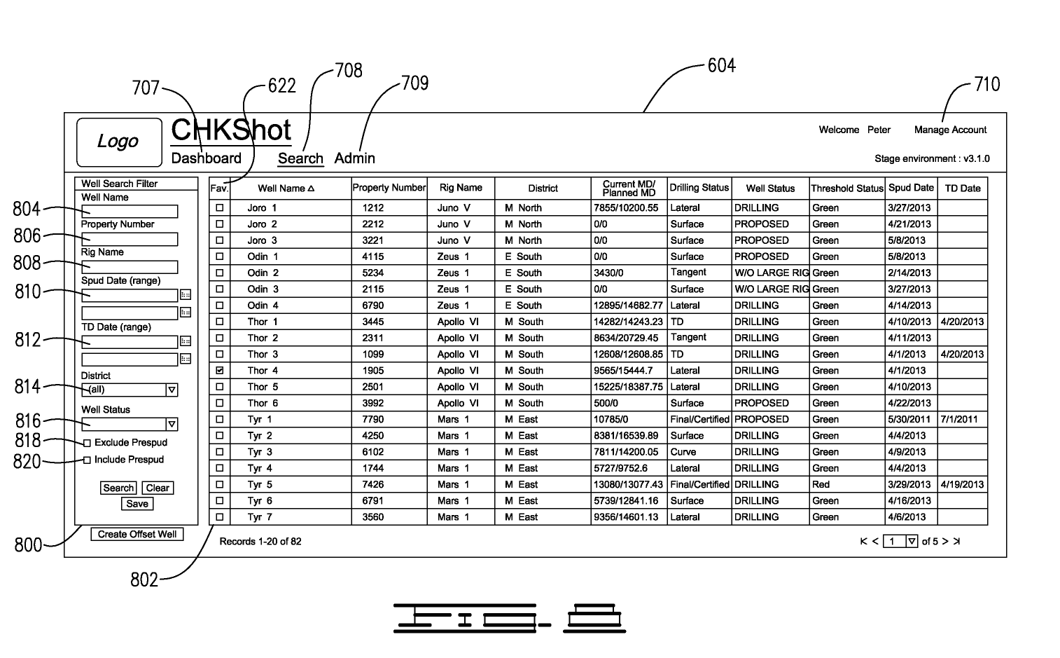

Returning to FIG. 6, search page 604 provides the user with a variety of search functionalities for searching the information stored within the system. Searching functionalities enable the users to search for drilling information based on well name, property number, rig name and other search criteria. An exemplary search page 604 is illustrated in FIG. 8. The search page 604 can be accessed by clicking on the search link on dashboard page 602. The search page has a search panel 800 with various search filters, such as Well Name 804, Property Number 806, Rig Name 808, Spud Date range 810, TD Date range 812, District 814 and Well Status 816. Spud Date range 810 filters by the date that drilling was commenced on the well. TD Date range 812 filters by the date that total depth was reached; that is the date that drilling was completed. Filters District 814 and Well Status 816 are shown as drop down menus; thus, clicking on the down arrow provides a list of available districts or well status options for the filter. Also, the user can filter to exclude wells at the filter Exclude PreSpud 818 where drilling has not commenced, or to include completed wells at the filter Include Completed 820. The user can save a search as a favorite search from Search panel 800. A Display panel 802 displays the search results and can include well name, property number, rig name, district, drilling status, well status, threshold status, spud date and similar. Further the user can set favorite wells from the display panel 802 by clicking on the favorites box 822.

Returning to FIG. 6, the system managers can perform various system administration and account administration functions through the administration page 606 in order to assist the system in operating in an optimal fashion. For example, the system managers can control the level of access of various users and can establish which users can have access to the system, and the users' roles and permissions within the system.

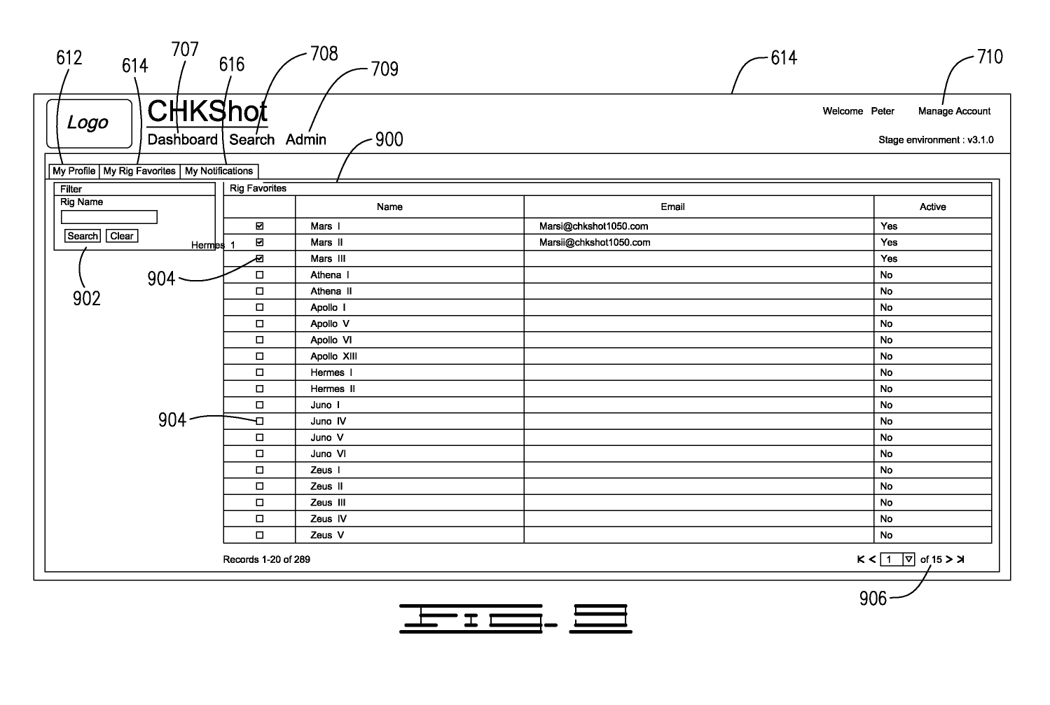

Manage account page 608 enables the user to manage various aspects of the user's account in drilling management system 100. Manage account functionalities can be broken down into various subfunctionalities by tabs on the manage account page 608, such as profile tab 612, rig favorites tab 614 and notification tab 616. Profile tab 612 enables the user to add, edit or change the user's profile, such as password, email address and similar. Rig favorites tab 614 allows each user to set rig favorites. Rig favorites appear on the user's dashboard page. An exemplary rig favorites tab 614 is illustrated in FIG. 9. From rig favorites tab 614, each user is able to set rig favorites by clicking on the appropriate selection box 904 in the rig favorites panel 900. The user can search through all the rigs in rig favorite panel 900 using paging function 906. Alternatively, the user can use Filter panel 902 to limit the rigs displayed in rig favorite panel 900 by all or a portion of the rig name.

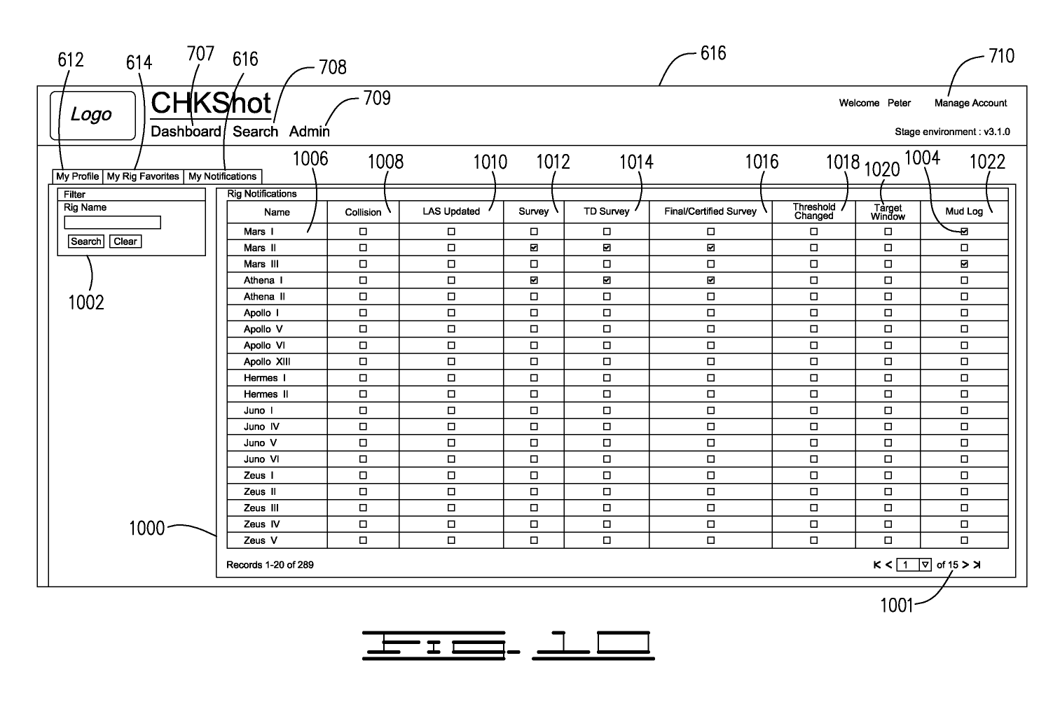

Notification tab 616 enables the user to select to receive notifications. An exemplary notifications tab 616 is illustrated in FIG. 10. From notifications 616, each user is able to set notifications received from the system for no-zone events, when information is uploaded to the drilling management system 100 and other well events. By clicking on the appropriate selection box in the rig notifications panel 1000, each user can select the notifications that will be sent to that user. The user can page through all the rigs in rig notifications panel 1000 by using paging function 1001 or can use filter panel 1002 to limit the rigs displayed in rig favorite panel 1000. For example, if mud log box 1004 for Mars I rig 1006 is checked, then the user will receive a notification when mud log information is uploaded to the drilling management system 100. Security can be set on the administration page by the system managers such that a user may only receive notifications for rigs on which that user is authorized.

As illustrated in FIG. 10, the user can select from collision 1008, LAS updated 1010, survey 1012, TD survey 1014, final/certified survey 1016, threshold changed 1018, target window 1020 and mud log 1022. Collision 1008 is for notifications when the wellbore being drilled is approaching a preexisting drilled wellbore. The notification would provide information on the potential collision including distance to the preexisting drilled wellbore. LAS updated 1010 is a notification for when LAS well information has been uploaded. The notification can include a copy of the LAS logs. Survey 1012 is for notifications when new MWD data has been loaded into the drilling management system. The notice can include a copy of the survey attached to the notice. TD survey 1014 is to receive notification of the final survey when drilling of the wellbore is completed. Final/certified survey 1016 is to receive notification when the final survey including any regulatory or other certification information has been uploaded. Threshold changed 1018 is to receive notification when threshold values for the well have been changed. Target window 1020 provides notifications on divergence from the target drill path. Mud log 1022 provides notification on when new mud log data has been uploaded. The notification can provide a copy of the new mud log data. The above notifications are exemplary. Additional notifications are within the scope of the invention and will be apparent from the disclosure herein.

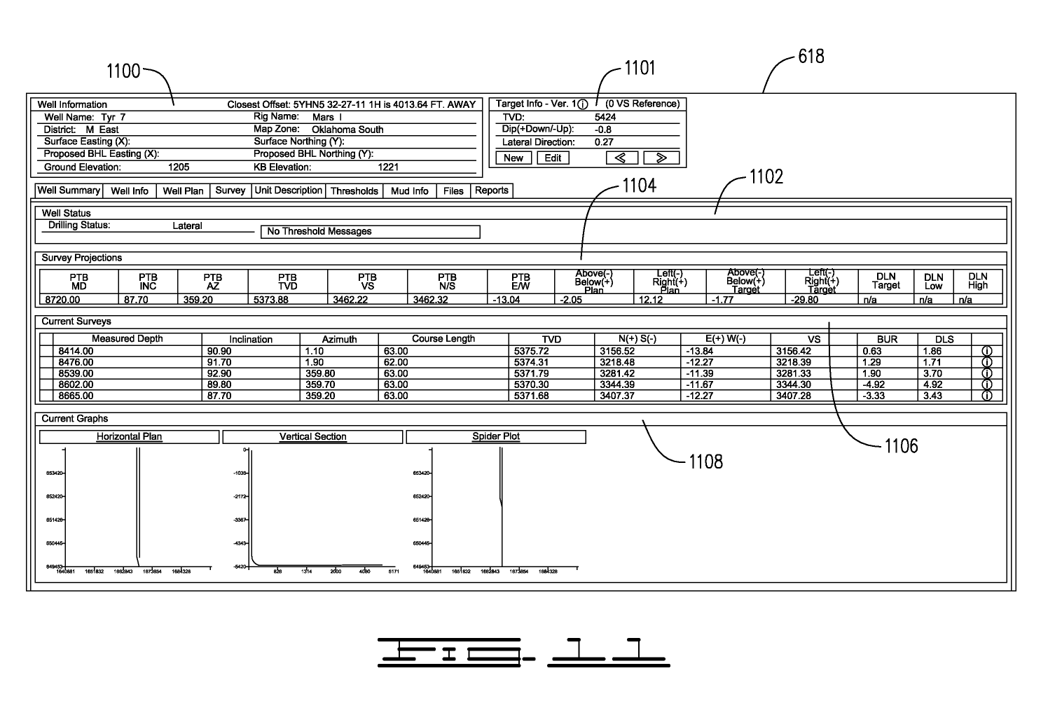

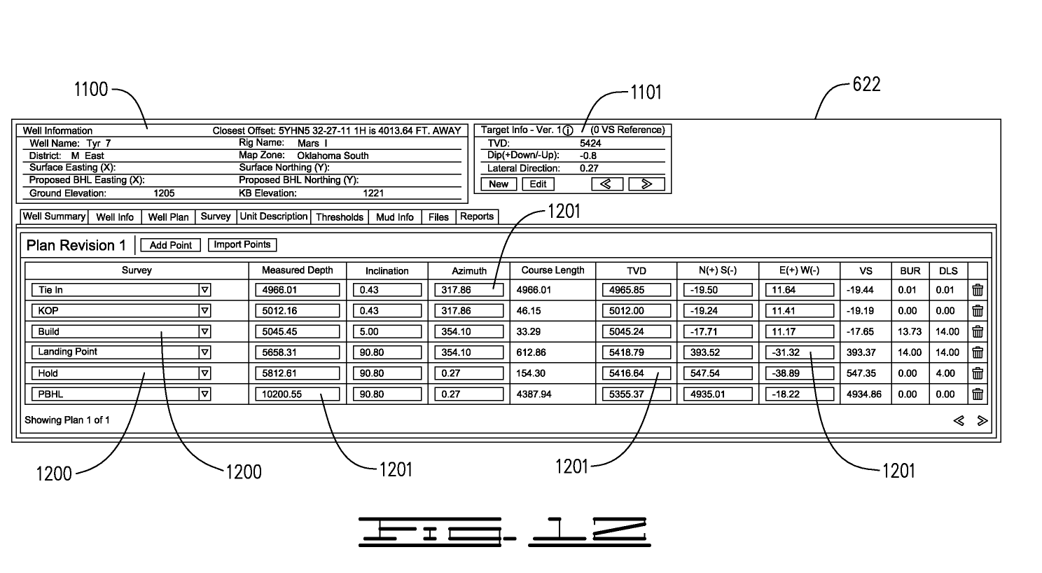

Returning to FIG. 6, well page 610 allows a user to have access to a variety of stored information on each well that the user has permission to access. Well functionality is broken down into subfunctionalities under various well page tabs, such as well summary tab 618, well information tab 620, well plan tab 622, survey tab 624, unit description tab 626, threshold tab 628, mud information tab 630, files tab 632 and reports tab 634. As can be seen from FIGS. 11 and 12, well page 610 displays basic well information 1100 and target information 1101, which can be seen from each tab display.

Well summary tab 618 displays such information as well status, thresholds messages, survey projections, current surveys and graphs of the drilling progress. An exemplary well summary tab 618 is illustrated in FIG. 11. Well summary tab 618 provides information on the subject well including well status 1102, survey projections 1104, current survey information 1106 and graphs 1108 of the current drilling progress. Graphs 1108 can be designed to be enlargeable by the user.

Returning to FIG. 6, well information tab 620 displays more detailed information related to the wellbore being drilled, such as well status, spud date, property number, API well number, well location, offset wells within a predefined range and similar.

Well plan tab 622 enables users with the appropriate access level to enter or revise target parameters for the drilling of the wellbore. Referring now to FIG. 12, there is illustrated well pan tab 622 of well page 610 which allows a well plan to be entered by well planner users of the drilling management system 100. By use of the drop down menus 1200 and entry boxes 1201, the well planner can enter or change targets associated with the well such as measured depth, inclination, azimuth and similar.

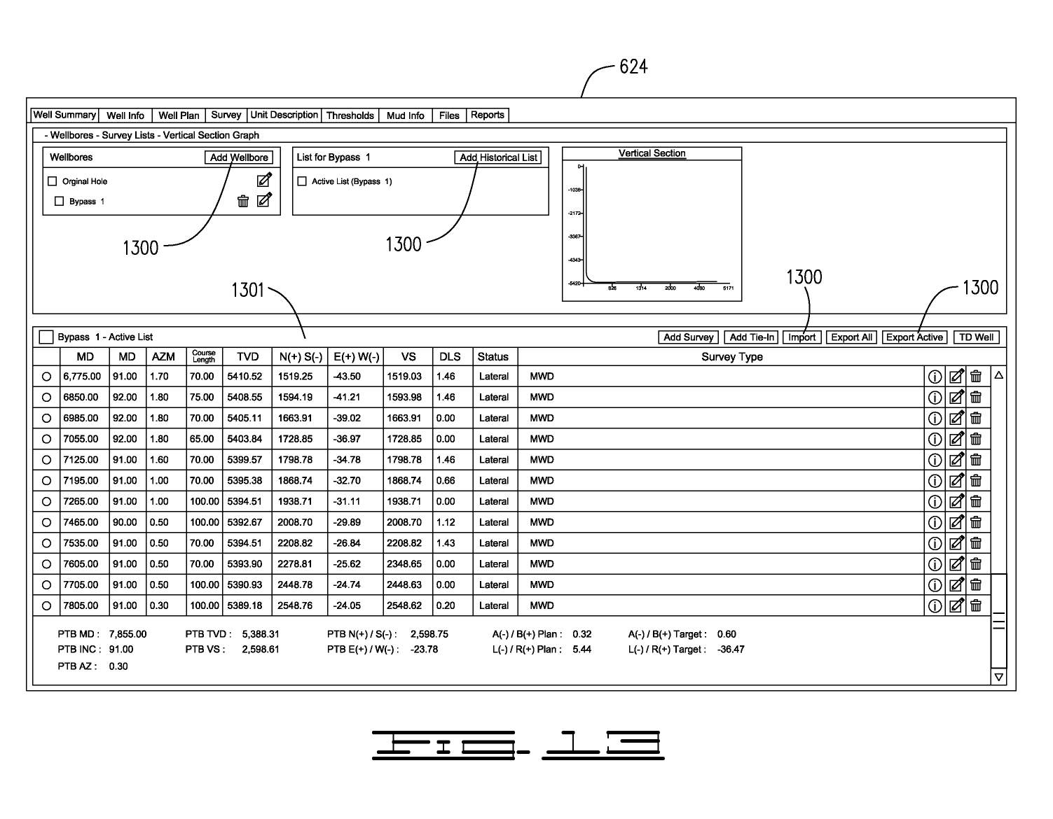

Returning to FIG. 6, survey tab 624 displays the well surveys or MWD data for the wellbore. An exemplary survey tab 624 is illustrated in FIG. 13. Survey tab 624 displays and allows manual entry of survey information. By use of functional buttons 1300, the user can manually add survey information or import or export survey information. Survey information is displayed in display portion 1301. Once surveys are entered under this tab, notifications are sent to those users who have elected to receive survey update notifications for the well.

Returning to FIG. 6, unit description tab 626 displays the boundary information for the tract or unit relating to the wellbore. Unit description tab 626 displays and allows manual entry of numeric and graphical information on the unit boundaries and offset associated therewith.

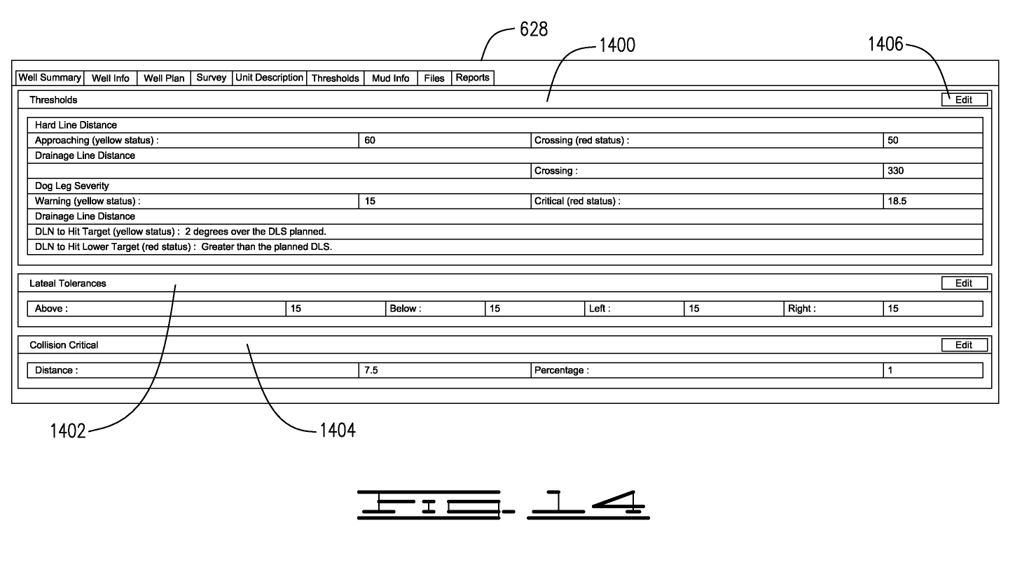

Threshold tab 628 enables users with the appropriate access level to view, enter and revise thresholds related to the well, such as thresholds for notifications when a wellbore being drilled is approaching an offset for a non-leased tract border. Additionally, thresholds can be set for other well criteria, such as dog-leg severity, lateral tolerance, collision critical values (notifications thresholds for the wellbore being drilled approaching a pre-existing wellbore) and similar. FIG. 14 illustrates an exemplary thresholds values tab 628. Current thresholds are displayed in the Thresholds panel 1400, Lateral Tolerances panel 1402 and Collision Critical Panel 1404. The thresholds can be edited by using edit button 1406.

Returning to FIG. 6, mud information tab 630 displays mud log information related to the drilling mud used in drilling the borehole. Mud information tab 630 also allows the uploading of mud log information into the drilling management system 100. Files tab 632 enables the uploading and downloading of files related to the well, drilling and borehole. Reports tab 634 allows access to well related data in a variety of report formats, such as PDF or Excel formats.

It should be understood that while the above functionalities of the drilling management system 100 have been described with reference to specific pages and tabs for the graphical user interface, other breakdowns of functionalities and designs for the graphical user interface can be utilized and are within the spirit and scope of the invention.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A computer-based system for managing data associated with drilling a wellbore, the system comprising:
at least one database for storing data associated with drilling including current data related to said wellbore currently being drilled and zone data related to a zone not to be drilled;
at least one server configured to generate a graphical user interface at a plurality of locations over a network wherein said graphical user interface enables viewing and entry of well-related data, and said server generates a plurality of electronic notifications wherein each notification is associated with at least one predefined well event occurring and wherein said server generates a comparison of said current data and said zone data, and one of said electronic notifications is a zone notification which is generated when said comparison indicates that said wellbore currently being drilled is within a predefined range from said zone not to be drilled.

2. The system of claim 1 wherein said zone not to be drilled is a preexisting drilled wellbore.

3. The system of claim 1 wherein said zone not to be drilled is a tract of land for which drilling rights have not been leased.

4. The system of claim 1 wherein said graphical user interface comprises a well plan page allowing entry and view of well target attributes.

5. The system of claim 1 wherein said graphical user interface includes a well summary page providing for a real-time summary of well attributes associated with said drilling of said wellbore.

6. The system of claim 5 wherein said well summary page includes a graphical representation of said wellbore.

7. The system of claim 1 wherein said graphical user interface includes a notifications page wherein a user can select which electronic notifications said user receives.

8. The system of claim 7 wherein said notification is an electronic message sent to an electronic address associated with said user.

9. The system of claim 8 wherein said notification is an email message sent to an email address associated with said user.

10. A computer-implemented method comprising:
providing zone data related to a zone not to be drilled;
providing current data related to a wellbore currently being drilled;
comparing said current data to said zone data; and
generating a zone notification when said comparing indicates said wellbore is within a predefined range from said zone.

11. The method of claim 10 wherein said zone not to be drilled is a preexisting drilled wellbore.

12. The system of claim 10 wherein said zone not to be drilled is a tract of land for which drilling rights have not been leased.

13. The method of claim 10 further comprising:
providing at least one database for storing data associated with drilling said wellbore including said current data and said zone data;
providing a graphical user interface at a plurality of locations over a network wherein said graphical user interface enables viewing and entry of well-related data; and
generating at least one electronic notification in addition to said zone notification wherein said electronic notification is associated with at least one predefined well event occurring.

14. The method of claim 13 wherein said graphical user interface comprises a well plan page allowing entry and view of well target attributes.

15. The method of claim 13 wherein said graphical user interface includes a well summary page providing for a real-time summary of well attributes associated with said drilling of said wellbore.

16. The method of claim 15 wherein said well summary page includes a graphical representation of said wellbore.

17. The system of claim 13 wherein said graphical user interface includes a notifications page wherein a user can select whether said user receives said electronic notification.

18. The system of claim 17 wherein said electronic notification and zone notification are electronic messages sent to an electronic address associated with said user.

19. The system of claim 18 wherein said electronic notification and zone notification are email messages sent to an email address associated with said user.

20. An article of manufacture including a non-transitory tangible computer readable storage medium having instructions thereon that, in response to execution by a computer-based system for managing data associated with drilling, cause said computer-based system to be capable of performing operations comprising:
comparing current data related to a wellbore currently being drilled to zone data related to a zone not to be drilled; and
generating a zone notification when said comparing indicates a wellbore is within a predetermined range from said zone.

21. The article of claim 20 further comprising:
generating at least one electronic notification in addition to said zone notification wherein said electronic notification is generated based upon data relating to said wellbore and provided to said computer-based system and is associated with at least one predefined well event occurring.

22. The article of claim 21 wherein said electronic notification and zone notification are electronic messages sent to a user.

23. The article of claim 22 wherein said electronic notification and zone notification are email messages sent to an email address associated with said user.
